(19) United States
(12) Patent Application Publication
(10) Pub. No.: US 2009/0145364 A1
(43) Pub. Date: Jun. 11, 2009

(54) LIVESTOCK TREATMENT CAROUSEL

(76) Inventors: John P. Hardy, Saranac, MI (US); Gabriel Ibarra-Jimenez, Orleans, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/033,387

(22) Filed: Feb. 19, 2008

Related U.S. Application Data
(60) Provisional application No. 60/933,389, filed on Jun. 6, 2007.

(51) Int. Cl. A01K 1/00

(52) U.S. Cl. 119/14.04; 119/14.01; 119/524; 119/518

(57) ABSTRACT

A livestock treatment carousel includes a rotatable platform and a plurality of fences. The rotatable platform has a substantially vertical axis of rotation. The fences define at least one stall for receiving livestock. Each of the fences has an inner end disposed toward the axis of rotation and an outer end opposite the inner end. The rotatable platform extends substantially beyond the stall, either inwardly or outwardly from the stall, or both inwardly and outwardly, for providing one or more walking areas on the platform for one or more attendants treating the livestock. The carousel may incorporate a movable gate at each of the fences. The movable gate closes to contain the livestock in the stall and opens to release the livestock from the stall.

### CROSS REFERENCE TO RELATED APPLICATION

The present invention claims the benefit of U.S. provisional application Ser. No. 60/933,389, filed Jun. 6, 2007, which is hereby incorporated herein by reference in its entirety.

### FIELD OF THE INVENTION

The present invention relates to livestock handling equipment.

### BACKGROUND OF THE INVENTION

Livestock or farm animals, such as cows, goats, sheep, horses, swine, ostrich, and the like, are typically examined and/or treated on a regular basis. Such examination and treatment may include, for example, pregnancy checks, insemination, health or veterinary examination, medication and vaccination, or the like. Such treatment often requires access to the animals' hindquarters or head by an attendant such as a veterinarian while the livestock is in a pen or a headlock.

### SUMMARY OF THE INVENTION

The present invention provides a livestock treatment carousel for facilitating the treatment of livestock. The carousel holds a plurality of individual animals in place and facilitates access to the animals' hindquarters by an attendant. The carousel is comprised mainly of a rotatable platform that extends beyond the livestock so that the attendant can walk, sit, stand, or maneuver outward of the livestock while traveling on the rotatable platform of the carousel with the livestock. The carousel may also extend inward toward the center of the carousel to provide a central maneuvering space and access to the inward end of the livestock. The attendant is thus able to perform health or other examinations, treatments, or other activities on a given animal while moving with the animal, and then move down to the next animal for treatment.

According to one form of the present invention, the carousel includes a rotatable surface and a plurality of fences. The rotatable surface has a substantially vertical axis of rotation. The fences define at least a portion of one stall region for receiving livestock. Each of the fences has an inner end disposed toward the axis of rotation and an outer end opposite the inner end. The rotatable surface extends substantially beyond the outer ends of the stall regions to create one or more treatment zones. Optionally, the rotatable surface may extend substantially inwardly beyond the inner ends of the stall regions to create one or more central treatment zones.

According to one aspect, the rotatable surface extends at least about twelve inches beyond the outer ends of the stall regions, and may extend at least about twenty-four inches or thirty inches or more beyond the stall regions. The carousel may further include a movable gate at each of the outer ends of the fences. The movable gate closes to contain the livestock in the stall region and opens to release the livestock from the stall and to permit livestock to enter the stall, The movable gate may automatically open to release livestock from the stall and/or to receive livestock into the stall, and automatically close to contain livestock in the stall. Optionally, the movable gate may be manually opened and/or closed.

According to another aspect, the carousel further comprises a loading surface and an unloading surface. The loading surface and the unloading surface are substantially level with the rotatable surface.

According to yet another aspect, the carousel includes a data display and input device at the rotatable surface. The display and input device may display data such as the identification number, preferred sire, pregnancy status, and health records of the livestock.

According to still another aspect, the carousel includes a stationary platform substantially surrounding the rotatable surface. A data display and input device may be included at the stationary platform.

According to a further aspect, the carousel may be used in combination with a movable gate for urging the livestock toward the rotatable surface.

According to a still further aspect, the carousel includes a controller for controlling the speed and direction of rotation of the carousel.

According to another aspect, the carousel includes a supply station for storing treatment supplies near the rotatable platform.

According to yet another aspect, the carousel includes a central treatment zone positioned inwardly of the stall regions for access to the livestock's heads or front regions. The central treatment zone may have a width of twelve inches or twenty-four inches, or may include the entire space located inward of the stall regions. The central treatment zone may be accessible via an inner movable gate at an inner end of one of the stall regions, so that an attendant may walk through an empty stall region via the outer gate and the inner gate to access the central treatment zone. The inner gate may be closed to contain livestock in the stall region and/or to prevent livestock from entering the central treatment zone. Optionally, a safety switch is triggered by an open gate to stop the carousel when the gate has inadvertently been left open.

According to another form of the present invention, a livestock milking and treating facility includes a milking parlor, a livestock treatment carousel, and at least one chute positioned between the milking parlor and livestock treatment carousel. The livestock treatment carousel is spaced from the milking parlor and includes a rotatable surface with a plurality of fences arranged thereon. The fences define at least one stall for receiving the livestock. Each of said fences has an inner end and an outer end opposite the inner end. The rotatable surface extends substantially beyond the outer ends of the fences. The chute guides livestock from the milking parlor to the livestock carousel.

According to an aspect, the livestock milking and treating facility further includes at least one sorting gate positioned at the chute. The sorting gate directs livestock in need of treatment toward the livestock treatment carousel and directs livestock not in need of treatment away from the livestock treatment carousel.

According to another form of the present invention, the carousel includes a rotatable surface and a plurality of fences. The rotatable surface has a substantially vertical axis of rotation. The fences define at least a portion of one stall region for receiving livestock. Each of the fences has an inner end disposed toward the axis of rotation and an outer end opposite the inner end. The rotatable surface extends substantially beyond the inner ends of the stall regions to create one or more inner treatment zones.

According to another form of the present invention, a method of treating livestock involves providing a rotatable surface having a stall region thereon with a treatment zone located radially outward of the stall region on the rotatable surface, wherein the zone is sufficiently large to accommodate a person. Livestock is then loaded into the stall region. A treatment attendant is positioned at the treatment zone, and the livestock is treated while the attendant moves with the carousel. Optionally, an attendant may access a central treatment zone located inward of the stall region via an inner gate and an outer gate at either end of an empty stall region in order to treat the livestock at the head or head end.

According to yet another form of the present invention, a method of treating livestock is provided. The method involves providing a rotatable planar surface having a stall region thereon, and providing a non-rotatable treatment zone substantially coplanar with the rotatable planar surface, the treatment zone being located radially outward of the rotatable planar surface. Livestock is loaded into the stall region. A treatment attendant is positioned at the treatment zone. The rotatable planar surface is rotated until the stall region is adjacent the attendant, and the livestock is treated. According to an aspect, the method further includes executing at least one function chosen from: (i) continuously rotating the rotatable planar surface, (ii) automatically indexing the successive stall regions into registry with the treatment zone for treatment and then rotating the rotatable planar surface after treating the livestock; and (iii) indexing the successive stall regions into registry with the treatment zone and rotating the rotatable planar surface upon receiving a command from the attendant.

Therefore, a device is provided that can receive a plurality of livestock on a rotating treatment carousel, on which one or more attendants are provided with an area of the carousel behind the livestock for access to the livestock's hindquarters for treatment purposes while the platform rotates, potentially substantially reducing the time spent by an attendant searching for specific livestock. The carousel may include a treatment area in front of the livestock for treatment at the head or front region. Attendants are thus able to remain stationary relative to the livestock, and the rotating carousel reduces the time during which livestock is detained without treatment. Data displays and data entry devices may also substantially reduce the time spent by an attendant searching for specific livestock. Thus, fewer attendants may be needed to treat the livestock than may otherwise be practical, and the livestock is able to spend more time at productive activities such as eating, lying/resting, socializing, and drinking.

These and other objects, advantages, purposes and features of the present invention will become apparent upon review of the following description in conjunction with the drawings.

### BRIEF DESCRIPTION OF THE DRAWINGS

FIG. 1 is a top plan view of a livestock treatment carousel of the present invention;

FIG. 2 is a perspective view of a portion of the livestock treatment carousel of FIG. 1;

FIG. 3 is a perspective view of a stall area of the livestock treatment carousel of FIG. 1;

FIG. 4 is a perspective view of a gate-opening system useful with the livestock treatment carousel;

FIG. 5 is a perspective view of a controller useful with the livestock treatment carousel;

FIG. 6 is a top plan view of a milking and treating facility incorporating the livestock treatment carousel of FIG. 1; and

FIG. 7 is a top plan view of another livestock treatment carousel of the present invention.

### DESCRIPTION OF THE PREFERRED EMBODIMENTS

Referring now to the drawings and the illustrative embodiments depicted therein, a livestock treatment carousel, one preferred form of which is referenced by the numeral 10, is provided for the treatment of livestock, such as cows, goats, sheep, horses, swine, ostrich, and the like. The carousel 10 has a round rotatable platform 12 with a plurality of stall fences 14 arranged thereon. Stall fences 14 at least partially define one or more stall regions or stalls 16 on platform 12. Movable gates 18 are provided at stall fences 14 for selectively enclosing stalls 16. A stationary platform 20 surrounds rotatable platform 12 and includes a loading ramp 22 and an unloading ramp 24 for facilitating the ingress and egress of livestock 26 into stalls 16. A treatment zone or walking space 28 about the perimeter of rotatable platform 12 allows an attendant to perform tests and treatments on the animals while moving with rotatable platform 12.

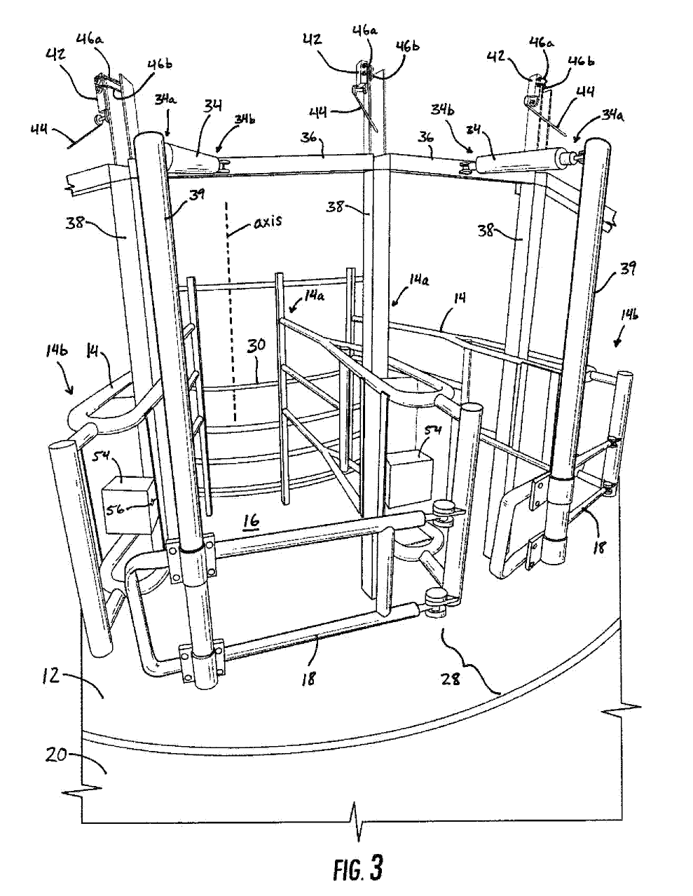

Rotatable platform 12 is a substantially round, planar, horizontal, and rotatable surface configured to support a plurality of animals or livestock 26 and livestock attendants 27 or herdsmen or veterinarians while rotating about a substantially vertical axis of rotation, indicated by a dotted line in FIG. 3. Platform 12 is supported on a floor surface by support structure, such as a plurality of wheels or bearings, and may be guided, for example, by a spindle at its axis of rotation, or by a circular track spaced from the axis of rotation. For example, suitable support and rotation structure is commonly used on the 72-stall Mag Autorotor available from WestfaliaSurge, Inc. of Naperville, Ill. Platform 12 may be coated or covered at its top surface by a non-skid and/or padded layer such as textured rubber or the like, to improve the footing of livestock 26 and attendants 27.

Rotatable platform 12 provides treatment zone or walking space 28 about its perimeter so as to be located radially outward of stalls 16. Walking space 28 is a portion of platform 12 that extends beyond fences 14 and provides adequate space for the attendants 27 to walk, stand, sit, and/or provide treatment to livestock 26 while remaining stationary relative to livestock 26. For example, walking space 28 may preferably be approximately twelve inches (305 millimeters) or greater in width. More preferably, walking space 28 is approximately twenty-four inches (610 millimeters) or greater in width. Even more preferably, walking space 28 may be approximately thirty inches (762 millimeters) or greater in width. Optionally, rotatable platform provides a central treatment zone at a central area 32 of platform 12, as will be described in greater detail below.

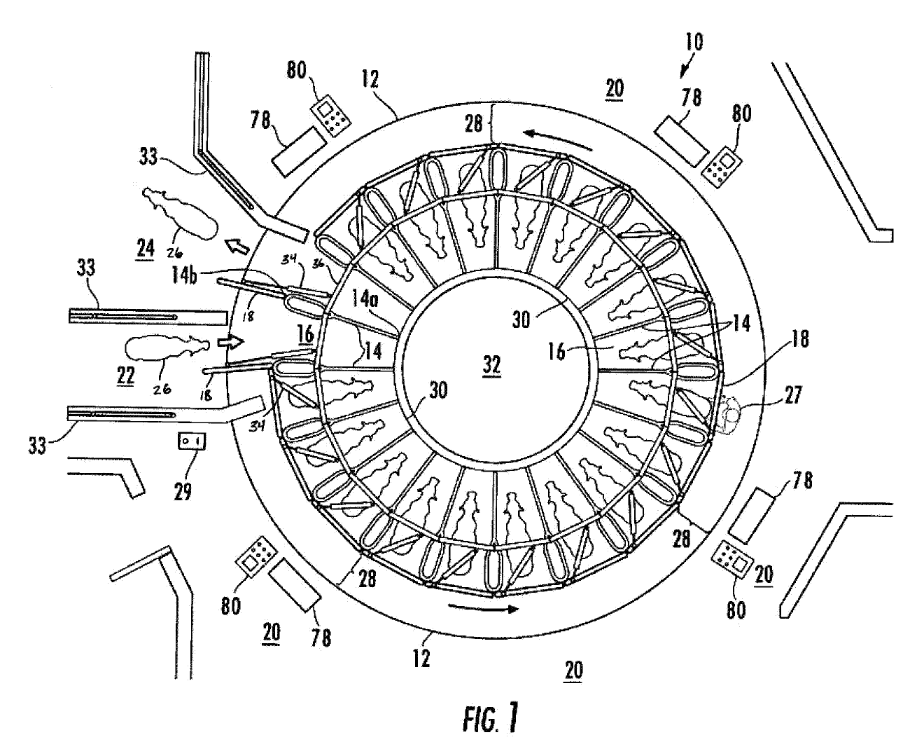

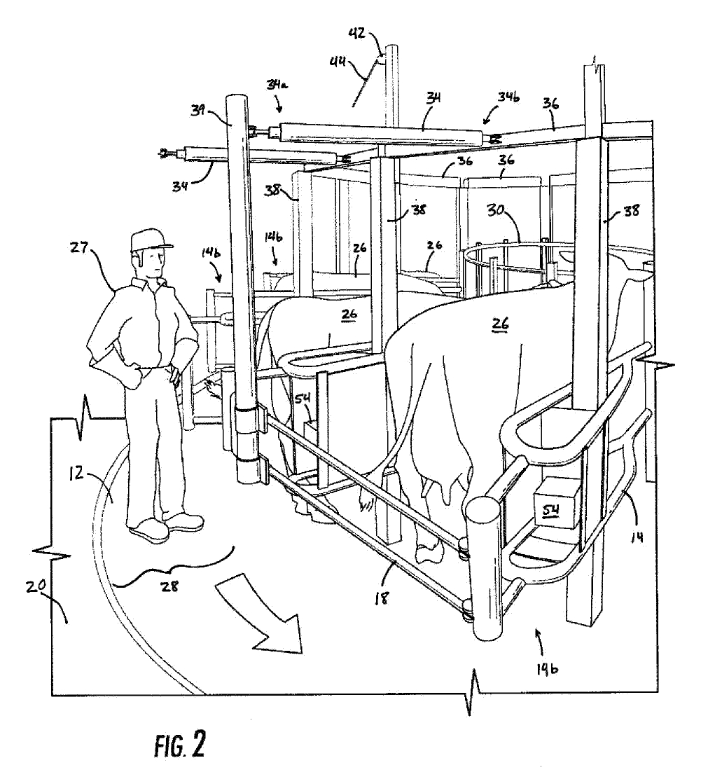

Rotatable platform 12 is supported at substantially the same height or elevation as stationary platform 20 to facilitate movement of livestock 26 and attendants 27 between rotatable platform 12 and stationary platform 20 while platform 12 is rotating. Platform 12 is rotatably driven by an electric motor, an hydraulic motor, a combustion engine, or the like, and may turn at a rate of approximately one revolution every nine minutes, for example, or may turn faster or slower depending upon the attendants' 27 and livestock's 26 particular needs. In the illustrated embodiment, curved arrows (FIGS. 1, 2, and 4) indicate the counterclockwise or forward direction of rotation of platform 12. However, it will be appreciated that platform 12 may be rotated in a clockwise or backward direction, without departing from the spirit and scope of the present invention. The rotation rate of platform 12 may be adjusted by a speed control 29 on stationary platform 20, or may be controlled by one or more alternative devices as will be described in greater detail below.

Fences 14 are arranged radially and stand substantially vertically on platform 12. Fences 14 have inner ends 14a and outer ends 14b, such that inner ends 14a are disposed toward the axis of rotation of platform 12, and outer ends 14b are disposed toward walking space 28 of platform 12. Inner ends 14a of fences 14 may terminate at a circular inner fence 30, for example, which prevents livestock 26 from entering central area 32 of platform 12. Alternatively, the inner fence may be in the shape of a polygon having a side spanning between each inner end 14a of fences 14. Optionally, the fences on the rotatable platform may extend radially-outward to the outer perimeter of the platform so that the treatment zone or walking space is divided into a separate zone for each stall region. In such an arrangement, attendants would be required to momentarily step off of the rotatable platform to change position from one treatment zone to another treatment zone.

Alternatively, the fences may be shorter in length than the livestock 26 and define adjacent stall regions without extending the full length of each stall. Shorter length fences may be located to have inner ends disposed toward the axis of rotation of the platform and outer ends that are only part way along the length of the livestock 26. Optionally, shorter fences may be positioned at the sides of the stall regions to extend for example, only along the midsection of the livestock 26.

Each stall fence 14 is equipped with gate 18 to selectively enclose stall 16 to contain livestock 26 therein. Gate 18 is pivotally mounted at outer end 14b of stall fence 14 and, optionally, engages a receiving element or latch (not shown) at an adjacent stall fence 14. Gate 18 is automatically moved between an open position and a closed position by a double-acting pneumatic cylinder 34 pivotally mounted to a cross member 36 supported between posts 38 that extend vertically from platform 12 through each stall fence 14 (FIGS. 1-3). Pneumatic cylinder 34 is further pivotably connected to a post 39 that extends upwardly from gate 18. Each gate 18 may be automatically opened and closed in response to one or more signals received from a switch or valve, as will be described in greater detail below. Alternatively, gate 18 may be automatically opened and closed by an electric or hydraulic actuator or the like, or may be manually operated. Alternatively, each stall 16 may be equipped with a gate that translates upwardly and downwardly to open and close, or that translates or pivots in another direction suitable for opening and closing stall 16, so as not to obstruct walking space 28 when the gate is open.

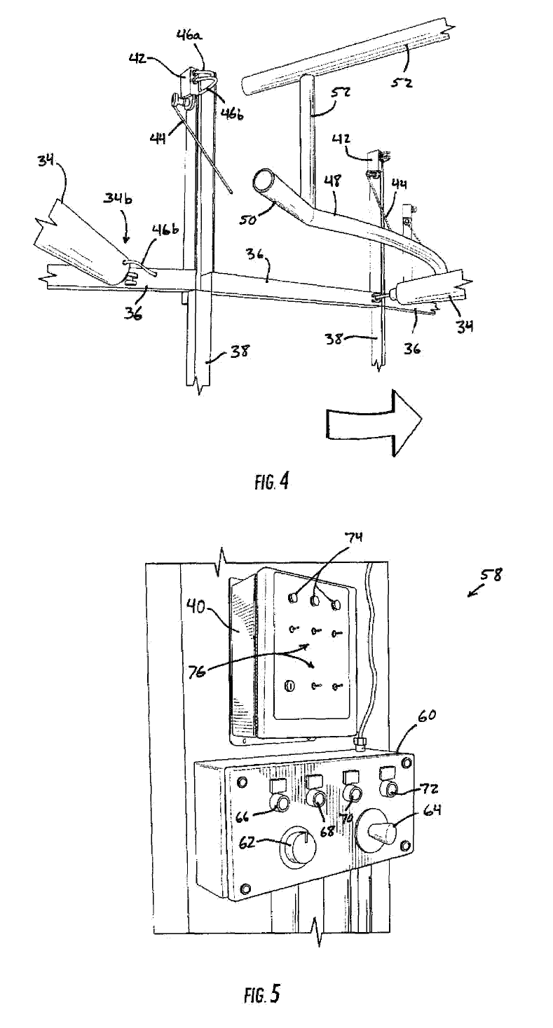

Optionally, and with reference to FIGS. 3 and 4, each stall 16 of treatment carousel 10 may be equipped with a pneumatic valve 42 mounted near a top portion of post 38. Valve 42 includes a spring-loaded actuator rod 44 pivotably mounted thereto for selectively directing a pressurized fluid, such as air, into one of two hoses 46a, 46b. Rod 44 is normally biased outwardly by a spring (not shown) and is inwardly pivotable against the force of the spring. When rod 44 is biased outwardly, valve 42 directs the pressurized fluid through hose 46a into a distal end 34a of pneumatic cylinder 34 to close gate 18. When rod 44 is pivoted inwardly, valve 42 directs the pressurized fluid through hose 46b into a proximal end 34b of pneumatic cylinder 34 to open gate 18.

An arcuate bar 48 having an outwardly-flared end 50 (FIG. 4) is positioned in the region of loading ramp 22 and unloading ramp 24 and is supported in a stationary position by support members 52. Arcuate bar 48 has a radius of curvature approximately equal to its radial distance from the axis of rotation of rotatable platform 12 so that each point along bar 48 is approximately equidistant from the axis of rotation of platform 12. Arcuate bar 48 is positioned so that the spring-loaded actuator rods 44 that are in contact with arcuate bar 48 are pivoted inwardly against the force of the spring in valve 42. Outwardly-flared end 50 extends-radially outwardly beyond the outward radial extent of spring-loaded actuator rod 44 so that rod 44 moves gradually inwardly as it moves along outwardly-flared end 50 toward arcuate bar 48.

Optionally, and as shown, stall fences 14 may be equipped with gate control boxes 54 and switches 56 (FIG. 3) for manually triggering an adjacent individual gate 18 to open. For example, attendant 27 may wish to leave one stall empty to provide access to the side or head of livestock 26 in an adjacent stall, and can trigger the gate of the empty stall to open by actuating switch 56, which opens the gate regardless of the position of the corresponding spring-loaded actuator rod.

Stationary platform 20 provides a stationary walking area for attendants 27 around rotatable platform 12. A portion of stationary platform 20 is segregated by ramp fences 33 to separate livestock areas (particularly loading ramp 22 and unloading ramp 24) from personnel areas. Ramp fences 33 further segregate livestock on loading ramp 22 from livestock 26 on unloading ramp 24 and, additionally, direct livestock 26 into stalls 16. Further, ramp fences 33 on either side of unloading ramp 24 may be spaced approximately three stall widths apart in order to facilitate the egress of livestock 26 from rotatable platform 12. Optionally, a second unloading surface may be provided for directing selected livestock to a quarantine area. In the illustrated embodiment, stationary platform 20 surrounds approximately eighty-five percent of platform 12, and loading ramp 22 and unloading ramp 24 combine to surround approximately fifteen percent of platform 12. It will be appreciated that the stationary platform, loading ramp, and unloading ramp may be adjusted to surround the rotatable platform to varying degrees, and may not fully surround the rotatable platform. Loading ramp 22 and unloading ramp 24 may be substantially horizontal and coplanar with rotatable platform 12, or may be positioned at an incline or a decline. Alternatively, it will be appreciated that livestock 26 may be loaded via unloading ramp 24 and unloaded via loading ramp 22, such as when rotatable platform 12 is rotated in a clockwise or backward direction as viewed from above, without departing from the spirit and scope of the present invention.

Referring now to FIG. 5, a control system 58 includes a platform controller 60 and a gate controller 40. Platform controller 60 has a speed control knob 62, an emergency-stop button 64, a motor oil/off button 66, directional controls such as a forward button 68 and a backward button 70, and a normal-stop button 72. Gate controller 40 includes status light indicators 74 and gate controls 76 for actuating movable gates (not shown) for urging livestock 26 onto loading ramp 22, for example. Control system 58 may be accessed by attendants 27 on stationary platform 20 to control the various functions of livestock treatment carousel 10.

Stationary platform 20 may incorporate a movable gate or fence for urging livestock 26 on loading ramp 22 toward rotatable platform 12. In addition to providing a stationary walking area for attendants, platform 20 may have one or more holding areas or supply stations 78 (FIG. 1) for storing supplies such as drugs, syringes, semen, and other supplies that are useful for the care and treatment of livestock 26. Supply stations 78 may be located anywhere on stationary platform 20, such as near rotatable platform 12, to provide convenient access to both livestock 26 and supply stations 78 from walking space 28 and/or stationary platform 20. Supply stations 78 may be positioned sufficiently close to walking space 28 to permit the attendant 27 to access supplies without leaving walking space 28.

Optionally, one or more user input and display devices 80 are provided at stationary platform 20 for displaying, receiving and entering data regarding a particular animal. The display device 80 is electronically connected to an identification tag reader and to a computer and/or a records database. The user input and display device 80 indicates a given animal's health records and permits attendant 27 to record data in a record, such as when a given animal requires additional treatment or additional examination in the future. For the breeding of animals, the display device 80 indicates an animal identification number and the preferred sire for insemination purposes, or may display the various sires available for insemination. For pregnancy checks, the display device 80 may indicate whether an animal is pregnant, and the user input device may include buttons to record data regarding whether the animal is determined to be pregnant, not pregnant, or whether pregnancy is unknown. The user input and display device 80 may also include a separate speed control so that attendant 27 may adjust the rotational rate of the rotatable platform 12 to allow for more or less time with a particular animal on platform 12 before that animal reaches unloading ramp 24. User input and display device 80 may be located on stationary platform 20, such as near rotatable platform 12, to provide attendants 27 with convenient access to both livestock 26 and user input and display device 80.

Additionally, attendants 27 may carry scanners and portable computers that are wirelessly linked to a computer and/or database to download, upload, and display data regarding a particular animal that an attendant has scanned. Optionally, a user input device and display may be provided at each stall fence 14 for displaying, receiving, and entering data regarding an animal in an adjacent stall.

Optionally, livestock treatment carousel 10 includes one or more electronic training devices (not shown) that are suspended above stalls 16 as they align with unloading ramp 24. The electronic training devices are used to train livestock 26 to exit stall 16 when the stall reaches unloading ramp 24 and gate 18 opens, and may include one or more electrically energized dangling electrical conductors, such as metal chains, that administer an irritating sensation to any livestock that is at risk of remaining in its stall as the stall rotates past unloading ramp 24.

Optionally, livestock treatment carousel 10 includes an emergency pull cord (not shown) that is accessible by attendant 27 located on walking space 28 and/or on stationary platform 20, to permit attendant 27 to halt the rotation of rotatable platform 12 in case the attendant detects a problem. The emergency pull cord may be electrically or mechanically connected to control system 58 to effect an emergency stop from a location that is remote from system 58.

Accordingly, the livestock treatment carousel 10 receives livestock 26 from loading ramp 22 into stalls 16 on platform 12. Preferably, the livestock is walked forward onto carousel 10, but in the alternative if livestock is backed onto the carousel 10, the relative treatment orientation is reversed. Optionally, livestock 26 on loading ramp 22 may have been pre-selected for treatment such that all livestock 26 located on ramp 22 is in need of some form of treatment, and livestock not requiring treatment is diverted away from treatment carousel 10, as will be described in greater detail below. Once an animal is received in stall 16, gate 18 pivots to block the hindquarters of the animal, thereby restraining the animal in stall 16. Attendant 27 reads data on the user input and display device 80 to determine what supplies are needed to treat the animal in the stall 16. If necessary, the attendant 27 retrieves supplies from station 78 and returns to stall 16 to attend to the animal restrained therein. The attendant 27 steps from walking space 28 of rotatable platform 12 to stationary platform 20 and back again as needed, as rotatable platform 12 rotates.

As best seen in FIGS. 3 and 4, when a given stall is not in the region of loading ramp 22 and unloading ramp 24, the associated rod 44 is biased outwardly by its spring, which causes valve 42 to direct pressurized fluid into distal end 34a of pneumatic cylinder 34, thus holding gate 18 closed. As a stall approaches unloading ramp 24 and arcuate bar 48, rod 44 initially contacts outwardly-flared end 50 and slides along end 50 as platform 12 continues to rotate, urging rod 44 radially inwardly until rod 44 contacts and begins sliding along arcuate bar 48. As rod 44 is urged radially inwardly, valve 42 stops directing pressurized fluid into distal end 34a of pneumatic cylinder 34 and begins directing pressurized fluid into proximal end 34b to urge gate 18 outwardly open and hold gate 18 open in the region of loading ramp 22 and unloading ramp 24. As the stall and valve approach the end of loading ramp 22, arcuate bar 48 terminates at an opposite outwardly-flared end (not shown), permitting rod 44 to be biased outwardly by the spring in valve 42, thus closing gate 18 until the gate once again approaches unloading ramp 24 and arcuate bar 48.

As platform 12 rotates, at least one attendant 27 may attend to each animal, and may read and enter data records for that animal before the animal reaches unloading ramp 24. In the event that attendant 27 desires access to the side or head of an animal, an adjacent stall 16 may be left empty and its gate 18 left open to provide this access, such as in the manner described above.

As stall 16 approaches unloading ramp 24, gate 18 opens and the animal is permitted to back out of stall 16 and onto unloading ramp 24, as directed by ramp fences 33. Once attendant 27 has completed treatment of a particular animal, the attendant 27 may walk around walking space 28 or platform 20 to enter data regarding the animal just treated, read data on the next animal in need of treatment, obtain supplies, and/or attend to the next animal in need of treatment. Thus, the process of treating animals is performed substantially constantly, and livestock 26 spends less time away from more productive activities, such as eating, resting, or exercising, than is otherwise practical.

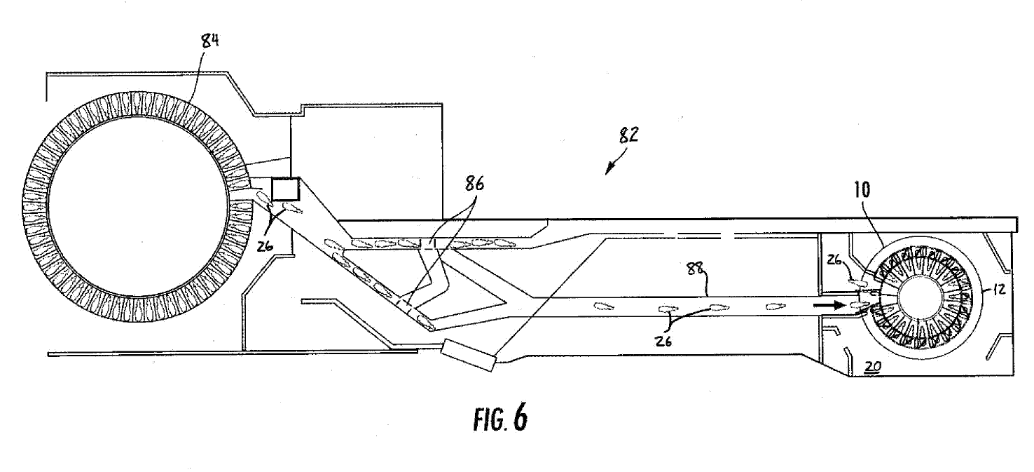

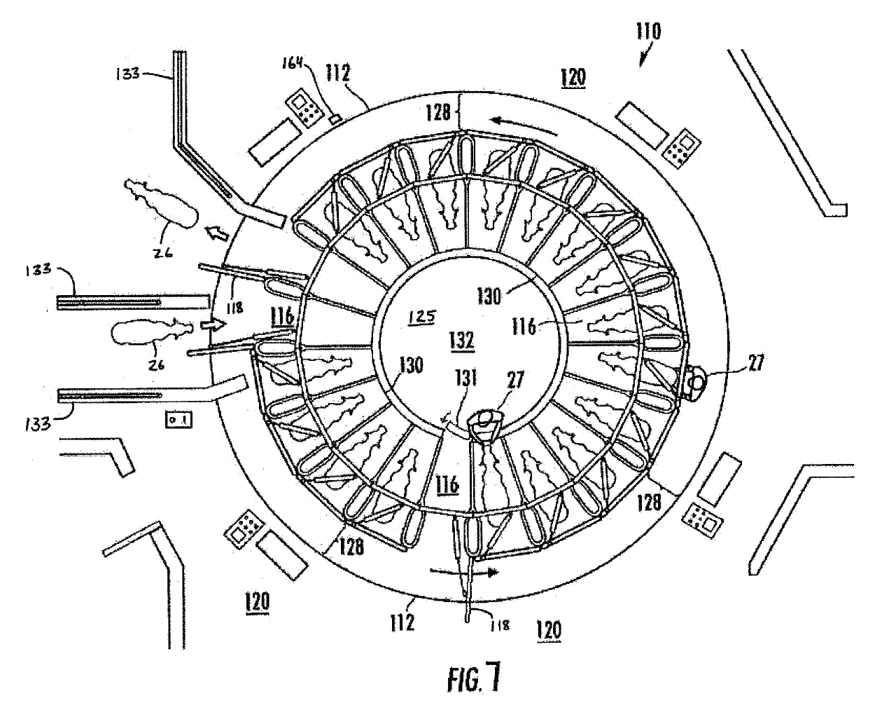

As will be appreciated by those skilled in the art, livestock treatment carousel 10 may be used in combination with other devices. For example, when carousel 10 is used for dairy cows, a milking/sorting/treating facility 82 may be provided (FIG. 6). Dairy cows may enter the facility 82 at a milking parlor such as a milking carousel 84 and then pass through sorting gates 86 which direct the dairy cows to any one of one or more pens (not shown), or to treatment carousel 10 via one or more chutes 88. Sorting gates 86 may be equipped with sensors that read data from transponders carried by the cows, and automatically swing or move in response to the data to direct cows in need of treatment toward treatment carousel 10 and to direct cows not in need of treatment away from treatment carousel 10. Dairy cows leaving treatment carousel 10 may be directed to one of a plurality of pens, for example, such as a feeding pen, a medical care pen, or a quarantine pen. Preferably, treatment carousel 10 operates at substantially the same rate at which cows in need of treatment are milked at milking carousel 84 so that cows (including those in need of treatment) are moved constantly through facility 82 without waiting for access to treatment carousel 10. Thus, facility 82 provides for the milking of all dairy cows, followed by the sorting of dairy cows in need of subsequent treatment from those that do not need treatment, and directing those dairy cows in need of treatment onto treatment carousel 10 for treatment thereon.

Optionally, and with reference to FIG. 7, an alternative livestock treatment carousel 110 includes a round rotatable platform 112 surrounded by a stationary platform 120. Various regions and components of carousel 110 that are substantially similar to regions and components of carousel 10 are given like numerals by the addition of 100, such that the regions and components may be understood with reference to the above discussion. Carousel 110 includes a central treatment region 125 that is accessible through an open gate 118 leading to an empty stall 116. A movable inner gate 131 along the inner fence 130 permits access to treatment region 125 from stall 116. Optionally, a tunnel or underpass (not shown) located under rotatable platform 112 permits access to central treatment region 125 via a hole, aperture, or trapdoor in central treatment region 125, similar to underpasses commonly used in conjunction with milking carousels. Alternatively, an overpass and ladder or stair (not shown) may be used to access central treatment region 125. Inner gates 131 may include manual or automatic headlocks so that livestock passing its head through gate 131 will be held in place for treatment by an attendant 27 standing in central treatment region 125. Optionally, a safety switch 164 may be provided in order to stop the rotation of platform 112 if gate 118 is inadvertently left open, in order to prevent damage to gate 118 as it approaches ramp fences 133. Safety switch 164 may be connected to one or more cables so that switch 164 may be triggered from locations remote from the switch. Optionally, another safety switch may be provided in order to stop the rotation of platform 112 if one of inner gates 131 is left open, in order to prevent livestock 26 from entering central treatment region 125.

Alternatively, a rotatable platform (not shown) has a perimeter edge that is adjacent outer ends of stall fences on the rotatable platform. A stationary platform is supported at substantially the same height or elevation as the rotatable platform and includes a treatment zone adjacent a perimeter edge of the rotatable platform. An attendant on the treatment zone thus has access to the hindquarters of livestock on the rotatable platform. For treatment requiring relatively little time to accomplish, a stationary attendant on the treatment zone of the stationary platform is provided with a relatively short period of access to a given animal as the animal moves past the attendant.

For treatment requiring relatively longer time to accomplish, a stationary attendant on the treatment zone of the stationary platform may be provided with a suitably longer period of access to a given animal via an indexing rotation system, for example. Indexed rotation may be performed automatically such as by rotating at a predetermined rate over a predetermined number of degrees of rotation, pausing for a predetermined time, and repeating the alternating process of rotating and pausing. Optionally, indexed rotation may be accomplished by an attendant entering one or more commands via a controller. Indexed rotation of a rotatable platform may be particularly useful when applied to the alternative rotatable platform having a stationary treatment zone located radially outward from the stalls, as described above. When incorporating indexed rotation, the rotatable platform turns until a given stall and animal are adjacent an attendant on the stationary treatment zone, stops for a period of time during which the attendant treats the animal, and then turns until a subsequent stall and animal are adjacent the attendant.

Changes and modifications to the specifically described embodiments may be carried out without departing from the principles of the present invention, which is intended to be limited only by the scope of the appended claims, as interpreted according to the principles of patent law including the doctrine of equivalents.

1. A livestock treatment carousel for facilitating the treatment of livestock, said carousel comprising:
a rotatable surface, said surface having a substantially vertical axis of rotation; and
a plurality of fences at said rotatable surface, said fences defining a stall region adapted to receive the livestock, wherein said stall region has an inner end disposed toward said axis of rotation and an outer end opposite said inner end, said rotatable surface extending outwardly from said stall region to form a treatment zone.

2. The livestock treatment carousel of claim 1, further comprising a movable gate at said outer end of said stall region, said movable gate adapted to close to contain the livestock in said stall region and open to release the livestock from said stall region.

3. The livestock treatment carousel of claim 2, wherein said movable gate automatically opens for releasing the livestock from said stall region and receiving livestock into said stall region and automatically closes for containing the livestock in said stall region.

4. The livestock treatment carousel of claim 1, wherein said rotatable surface extends outwardly at least about twelve inches beyond said stall region.

5. The livestock treatment carousel of claim 4, wherein said rotatable surface extends outwardly at least about twenty-four inches beyond said stall region.

6. The livestock treatment carousel of claim 5, further comprising a movable gate at said outer end of said stall region, said movable gate adapted to close to contain the livestock in said stall region and open to release the livestock from said stall region.

7. The livestock treatment carousel of claim 1, wherein said rotatable surface extends inwardly from said stall region to form a central treatment zone, said central treatment zone extending at least about twelve inches inwardly from said stall region.

8. The livestock treatment carousel of claim 7, further comprising a movable inner gate at each of said inner ends of said stalls, said movable inner gate adapted to close to contain the livestock in said stall region and open to permit access to said central treatment zone by an attendant.

9. The livestock treatment carousel of claim 7, wherein said central treatment zone extends inwardly at least about twenty-four inches inwardly from said stall regions.

10. The livestock treatment carousel of claim 1, further comprising a controller adapted to control the rotational speed and the rotational direction of said rotatable surface.

11. The livestock treatment carousel of claim 1, further comprising a stationary platform substantially surrounding said rotatable surface.

12. The livestock treatment carousel of claim 11, wherein said stationary platform comprises a loading surface and an unloading surface adapted to permit ingress and egress of the livestock onto and off of said rotatable platform.

13. The livestock treatment carousel of claim 11, further comprising a user input and display device at said stationary platform, said user input and display device adapted to receive and display data regarding the livestock.

14. The livestock treatment carousel of claim 13, wherein said user input and display device displays at least one chosen from (i) identification number, (ii) preferred sire, (iii) pregnancy status, and (iv) health records.

15. A livestock treatment carousel for facilitating the treatment of livestock, said carousel comprising:
a rotatable platform having at least one stall region and at least one treatment zone located radially outward of said stall region;
a plurality of fences supported at said rotatable platform and defining said stall region; and
a gate at said stall region, said gate adapted to separate said stall region from said treatment zone;
wherein said stall region is adapted to releasably contain a livestock animal therein, said treatment zone is adapted to permit an attendant to access the livestock animal, and said gate is movable to selectively permit access to said stall region.

16. The livestock treatment carousel of claim 15, wherein said fences are arranged radially and have inner ends disposed toward the axis of rotation of said rotatable platform and outer ends disposed toward said treatment zone.

17. The livestock treatment carousel of claim 16, further comprising a circular inner fence, wherein said inner ends of said fences terminate at said circular inner fence and said outer ends of said fences terminate at said gate to enclose said stall region.

18. The livestock treatment carousel of claim 16, wherein said rotatable surface extends inwardly from said circular inner fence to form a central treatment zone, and wherein said circular inner fence comprises at least one movable inner gate, said movable inner gate adapted to close to contain the livestock in said stall region and open to permit access to said central treatment zone by an attendant.

19. The livestock treatment carousel of claim 15, wherein said gate automatically opens for releasing the livestock from said stall region and receiving livestock into said stall region and automatically closes for containing the livestock in said stall region.

20. The livestock treatment carousel of claim 15, further comprising a safety switch, said safety switch adapted to be engaged by said gate when said gate is in an open position, said safety switch configured to prevent rotation of said rotatable platform.

21. A livestock treatment carousel for facilitating the treatment of livestock, said carousel comprising:
a rotatable planar surface, said surface having a substantially vertical axis of rotation;
a plurality of fences at said rotatable surface, said fences defining a plurality of stalls adapted to receive livestock, wherein each of said fences has an inner end disposed toward said axis of rotation and an outer end opposite said inner end, said rotatable surface extending at least about twelve inches beyond said outer ends of said fences and providing a walking space for an attendant;
an automatic gate at each of said outer ends of said fences, said automatic gate being adapted to automatically open for releasing the livestock from said stalls and receiving livestock into said stalls, and adapted to automatically close for containing the livestock in said stalls; and
a stationary platform substantially surrounding said rotatable planar surface, said stationary platform and said rotatable planar surface being substantially coplanar.

22. The livestock treatment carousel of claim 21, further comprising an override switch adapted to open and close one of said automatic gates.

23. The livestock treatment carousel of claim 21, wherein said rotatable planar surface extends at least about twenty-four inches beyond said outer ends of said fences.

24. The livestock treatment carousel of claim 21, further comprising a circular inner fence, wherein said inner ends of said fences terminate at circular inner fence and said outer ends of said fences terminate at said gate to enclose said stalls, and wherein said rotatable planar surface extends inwardly from said circular inner fence to form a central treatment zone, said circular inner fence comprising a movable inner gate at least one of said stalls, said movable inner gate adapted to close to contain the livestock in said stalls and open to permit access to said central treatment zone by an attendant.

25. A livestock treatment carousel for facilitating the treatment of livestock, said carousel comprising:
a rotatable surface, said surface having a substantially vertical axis of rotation; and
a plurality of fences at said rotatable surface, said fences defining a stall region adapted to receive the livestock, wherein said stall region has an inner end disposed toward said axis of rotation and an outer end opposite said inner end, said rotatable surface extending inwardly from said inner end of said stall region to form an inner treatment zone.

26. The livestock treatment carousel of claim 25, wherein said rotatable surface extends outwardly from said stall region to form an outer treatment zone.

27. The livestock treatment carousel of claim 26, further comprising an outer gate at said outer end of said stall region and an inner gate at said inner end of said stall region, said inner gate adapted to permit entry of an attendant from said stall region into said inner treatment zone.

28. A livestock milking and treating facility comprising:
a milking parlor;
a livestock treatment carousel spaced from said milking parlor, said livestock treatment carousel comprising a rotatable surface and a plurality of fences at said rotatable surface, said fences defining at least one stall adapted to receive the livestock, wherein each of said fences has an inner end and an outer end opposite said inner end, said rotatable surface extending substantially beyond said outer ends of said fences; and
at least one chute positioned between said milking parlor and said livestock treatment carousel, said at least one chute adapted to guide livestock from said milking parlor to said livestock treatment carousel.

29. The livestock milking and treating facility of claim 28, further comprising at least one sorting gate positioned at said at least one chute, said sorting gate adapted to direct livestock in need of treatment toward said livestock treatment carousel and to direct livestock not in need of treatment away from said livestock treatment carousel.

30. A method of treating livestock, said method comprising:
providing a rotatable surface having a stall region disposed thereon and a treatment zone located radially outward of said stall region on said rotatable surface, wherein said zone is sufficiently large to accommodate a person standing thereon;
rotating said rotatable surface;
loading the livestock into said stall region;
positioning an attendant at said treatment zone; and
treating the livestock while the attendant moves with said rotatable surface.

31. The method of claim 30, wherein said loading the livestock into said stall region comprises:
providing a gate at said stall region;
opening said gate;
urging the livestock past said gate and into said stall region; and
closing said gate.

32. The method of claim 31, further comprising:
providing an automatic gate opener at said gate;
opening said gate by actuating said automatic gate opener; and
closing said gate by actuating said automatic gate opener.

33. The method of claim 30, further comprising:
providing a central treatment zone located radially inward of said stall region on said rotatable surface;
positioning an attendant at said central treatment zone; and
treating the livestock with the attendant at said central treatment zone.

34. The method of claim 33, further comprising:
providing an inner gate at an inner end of a second stall region;
opening an outer gate at said second stall region;
opening said inner gate at said second stall region; and
passing the attendant through said second stall region and into said central treatment zone via said outer gate and said inner gate of said second stall region.
